(19) United States
(12) Patent Application Publication
(10) Pub. No.: US 2021/0321057 A1
(43) Pub. Date: Oct. 14, 2021

(54) MEMORY CIRCUIT AND IMAGING APPARATUS

(71) Applicant: Sony Semiconductor Solutions Corporation, kanagawa (JP)

(72) Inventor: Ryohei Kawasaki, Kanagawa (JP)

(21) Appl. No.: 17/271,849

(22) PCT Filed: Aug. 9, 2019
(86) PCT No.: PCT/JP2019/031675

§ 371 Date: Feb. 26, 2021

(30) Foreign Application Priority Data
Oct. 12, 2018 (JP) 2018-193011

(51) Int. Cl. H04N 5/3745; G06F 3/06

(52) U.S. Cl. CPC H04N 5/3745; G06F 3/0673; G06F 3/0604; G06F 3/0655

(57) ABSTRACT

In a memory circuit that stores pixel data, the pixel data is read out in a predetermined order.

A plurality of memory elements stores the values of a plurality of pixels. A counter sequentially outputs count values is synchronization with a clock. A plurality of decoders is provided for the plurality of memory elements in one-to-one correspondence. When detecting that the count value has reached a predetermined value, the plurality of decoders performs control to read the stored contents from the corresponding memory elements. An output unit outputs the stored contents read from one of the plurality of memory elements.

### TECHNICAL FIELD

The present technology relates to memory circuits. More specifically, the present technology relates to a memory circuit that stores pixel data, and an imaging apparatus that includes the memory circuit.

### BACKGROUND ART

In a conventional imaging apparatus, pixel data read from the pixel array is temporarily stored in a data memory unit. After that, the pixel data is read out in accordance with a word address in the pixel region, and is transferred for processing in a later stage. For example, there is a suggested imaging apparatus that performs reading is accordance with a control signal that controls the readout timing (see Patent Document 1, for example).

### CITATION LIST

### Patent Document

Patent Document 1: WO 2018/037902 A

### SUMMARY OF THE INVENTION

### Problems to be Solved by the Invention

In the conventional technology described above, a control line of the control signal for selecting a memory element is provided globally, and the pixel data at the same address in each unit in the pixel region is sequentially read out to reduce the number of transitions of the control line. Therefore, to output pixel data to the outside of the sensor while maintaining the pixel sequence, it is necessary to hold the pixel data of the entire frame in a frame memory and then perform rearrangement.

The present technology has been developed in view of such circumstances, and aims to read pixel data in a predetermined order in a memory circuit that stores pixel data.

### Solutions to Problems

The present technology has been developed to solve the above problems, and a first aspect thereof is a memory circuit and an imaging apparatus that include: a plurality of memory elements; a counter that sequentially outputs a count value in synchronization with a clock; a plurality of decoders provided for the respective memory elements, the decoders performing control to read stored contents from the corresponding memory elements when detecting that the count value reaches a predetermined value; and an output unit that outputs stored contents read from one of the plurality of memory elements. Thus, the decoders detect that the count value has reached the predetermined value, and stored contents are effectively read from the corresponding memory elements.

Also, in the first aspect, the plurality of decoders may detect different values from one another as the predetermined values. Thus, one of the memory elements exclusively reads out the stored contents.

Also, in the first aspect, the output unit may include a plurality of output circuits that output stored contents from different memory elements of the plurality of memory elements in accordance with the count value. Thus, the pairs of a memory element and a decoder are divided and are flexibly arranged.

Also, in the first aspect, the memory circuit and the imaging apparatus may further include a transfer unit that has a plurality of stages of shift registers that transfer an output from the output unit to the next stage in synchronization with the clock. Thus, the stored contents read from the memory elements are sequentially output and transferred.

Also, in the first aspect, the shift registers may include first and second shift registers synchronized with the clock, and the plurality of memory elements, the plurality of decoders, and the counter may be provided for each of the first and second shift registers. Alternatively, the plurality of memory elements and the plurality of decoders may be provided for each of the first and second shift registers, and the counter may be shared between the first and second shift registers. Further, the plurality of memory elements may be provided for each of the first and second shift registers, and the counter and the plurality of decoders may be shared between the first and second shift registers.

Also, in the first aspect, the plurality of memory elements, the plurality of decoders, and the counter may constitute a predetermined cluster, the counter may sequentially output the count value when the cluster is selected by a cluster selection signal, and the output unit may output the read stored contents when the cluster is selected by the cluster selection signal. That is, reading from the memory elements is controlled on a cluster basis. In this case, the memory circuit and the imaging apparatus may further include a transfer unit that has a plurality of stages of shift registers that transfer an output from the output unit to the next stage in synchronization with the clock, and an output of one of the clusters may be supplied to each of the shift registers in the plurality of stages. Further, a plurality of the clusters may be connected to each of the shift registers in the plurality of stages, and an output from the cluster selected by the cluster selection signal may be supplied.

### BRIEF DESCRIPTION OF DRAWINGS

FIG. 1 is a block diagram showing an example configuration of an imaging apparatus 80 according to an embodiment of the present technology.

FIG. 2 is a diagram showing an example chip structure of the imaging apparatus 80 according to the embodiment of the present technology.

FIG. 3 is a diagram showing an example of a cluster according to the embodiment of the present technology.

FIG. 4 is a diagram showing an example floor plan of a circuit chip 20 according to the embodiment of the present technology.

FIG. 5 is a diagram showing an example of a repeater 30 according to the embodiment of the present technology.

FIG. 6 is a diagram showing an example configuration of an AD converter circuit 200 according to the embodiment of the present technology.

FIG. 7 is a diagram showing an example circuit configuration of the AD converter circuit 200 according to the embodiment of the present technology.

FIG. 8 is a diagram showing an example operation timing of an AD converter circuit 200 according to the embodiment of the present technology.

FIG. 9 is a diagram showing an example circuit configuration of a cluster according to the embodiment of the present technology.

FIG. 10 is a diagram showing an example circuit configuration related to cluster reading in the embodiment of the present technology.

FIG. 11 is a diagram showing an example block configuration related to reading in a cluster according to the first embodiment of the present technology.

FIG. 12 is a diagram showing an example timing of an operation related to reading in a cluster according to the embodiment of the present technology.

FIG. 13 is a diagram showing an example of a read access image in a case where the width of a repeater 30 in the embodiment of the present technology is one pixel column.

FIG. 14 is a diagram showing an example of a read access image in a case where the width of a repeater 30 in the embodiment of the present technology is two pixel columns.

FIG. 15 is a diagram showing an example of a read access image in a case where the width of a repeater 30 in the embodiment of the present technology is four pixel columns.

FIG. 16 is a diagram showing a cluster configuration expected in a case where any decoder is not used.

FIG. 17 is a diagram showing a comparative example of a control wiring image.

FIG. 18 is a diagram showing an example block configuration related to reading in a cluster according to a second embodiment of the present technology.

FIG. 19 is a diagram showing an example block configuration related to reading in a cluster according to a third embodiment of the present technology.

FIG. 20 is a diagram showing an example block configuration related to reading in a cluster according to a fourth embodiment of the present technology.

FIG. 21 is a diagram showing an example block configuration related to reading in a cluster according to a fifth embodiment of the present technology.

FIG. 22 a diagram schematically showing an example configuration of an endoscopic surgery system.

FIG. 23 is a block diagram showing an example of the functional configurations of a camera head and a CCU.

FIG. 24 is a block diagram schematically showing an example configuration of a vehicle control system.

FIG. 25 is an explanatory diagram showing an example of installation positions of external information detectors and imaging units.

### MODES FOR CARRYING OUT THE INVENTION

The following is a description of modes for carrying out the present technology (the modes will be hereinafter referred to as the embodiments). Explanation will be made in the following order.

1. First embodiment (an example in which a decoder that decodes the count value of a clock counter is provided in each memory element)

2. Second embodiment (an example in which a plurality of output buffers is provided)

3. Third embodiment (an example in which a clock counter is shared between clusters of adjacent repeaters)

4. Fourth embodiment (an example in which a clock counter and decoders are shared between clusters of adjacent repeaters)

5. Fifth embodiment (an example in which a plurality of clock counters is provided for one cluster)

6. Example application to an endoscopic surgery system

7. Example applications to mobile structures

### 1. First Embodiment

### [Example Configuration of an Imaging Apparatus]

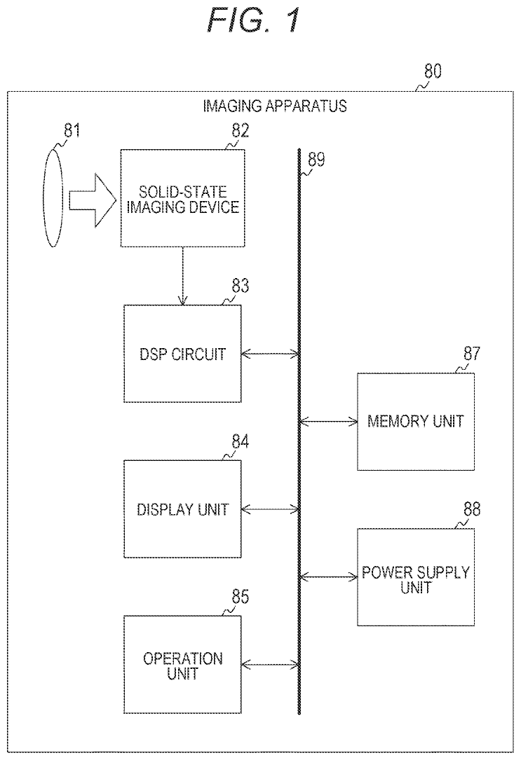

FIG. 1 is a block diagram showing an example configuration of an imaging apparatus 80 according to an embodiment of the present technology.

The imaging apparatus 80 is an apparatus for capturing an image of an object, and includes a solid-state imaging device 82, a digital signal processing (DSP) circuit 83, a display unit 84, an operation unit 85, a memory unit 87, and a power supply unit 88. These components are connected to one another by a bus 89. The imaging apparatus 80 may be a digital camera such as a digital still camera, a smartphone or a personal computer having an imaging function, an in-vehicle camera, or the like, for example.

The solid-state imaging device 82 generates pixel data by photoelectric conversion. An optical system 81 is provided on the entire surface of the solid-state image solid-state imaging device 82, and light from the object is gathered and is guided to the solid-state imaging device 82. The solid-state imaging device 82 supplies the generated pixel data to the DSP circuit 83 in a later stage.

The DSP circuit 83 performs predetermined signal processing on the pixel data from the solid-state imaging device 82. The display unit 81 displays the pixel data. The display unit 84 may be a liquid crystal panel or an organic electroluminescence (EL) panel, for example. The operation unit 85 generates an operation signal in accordance with a user operation. The memory unit 87 stores various kinds of data such as the pixel data. The power supply unit 68 supplies power to the solid-state imaging device 82, the DSP circuit 83, the display unit 84, and the like.

### [Chip Structure]

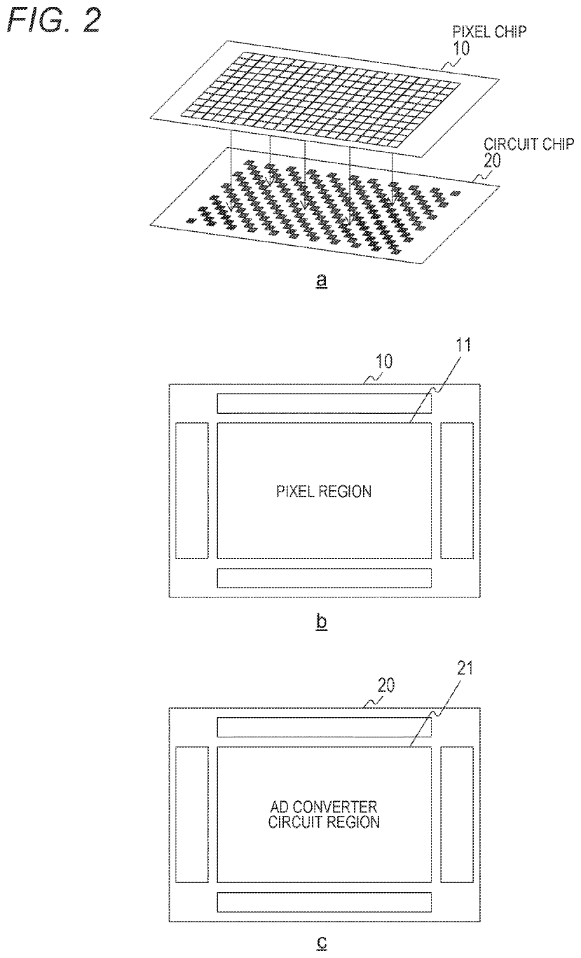

FIG. 2 is a diagram showing an example chip structure of the imaging apparatus 80 according to the embodiment of the present technology.

Here, the chip structure of the imaging apparatus 80 is a hierarchical structure formed with a pixel chip 10 and a circuit chip 20, as shown in a in the drawing.

As shown in b in the drawing, the pixel chip 10 that includes a pixel region 11 as its principal component, and the pixel region 11 is formed with a plurality of pixels arranged is a two-dimensional manner. A horizontal drive circuit, a vertical drive circuit, and the like for driving the pixels are provided around the pixel region 11 as appropriate.

As shown is c in the drawing, the circuit chip 20 is a chip that includes an AD converter circuit region 21 as its principal component, and the AD converter circuit region 21 is formed with a plurality of analog-to-digital (AD) converter circuits arranged in a two-dimensional manner. A drive circuit, a logic circuit, and the like for driving the AD converter circuits are provided around the AD converter circuit region 21 as appropriate.

The pixel chip 10 and the circuit chip 20 are electrically connected to each other via connecting portions such as vias. Note that the connection can also be achieved with members other than vias, such as Cu—Cu junctions or bumps, or by an inductively coupled communication technology such as ThruChip Interface (TCI).

### [Cluster]

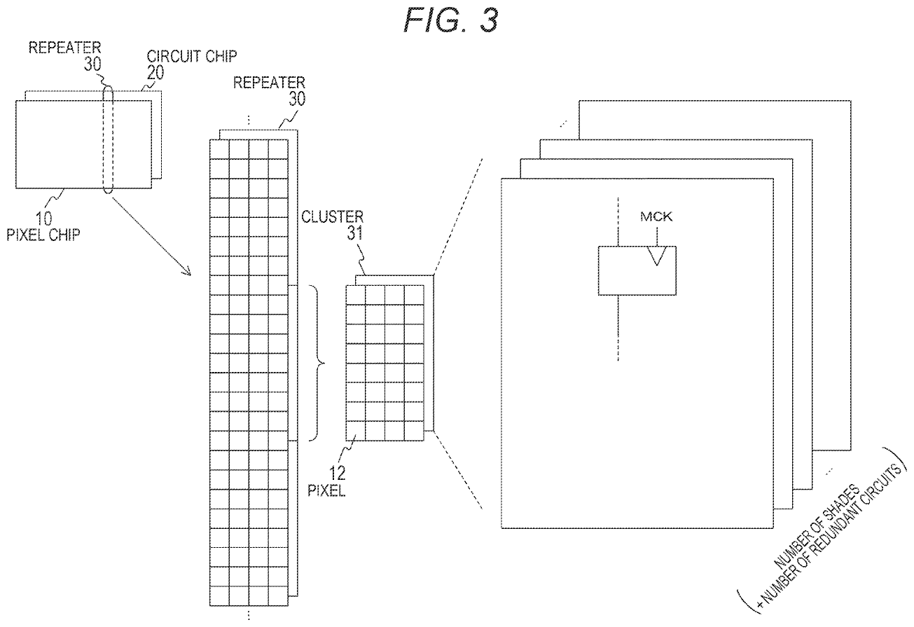

FIG. 3 is a diagram showing an example of a cluster according to the embodiment of the present technology.

As described above, the imaging apparatus 80 has a hierarchical structure formed with the pixel chip 10 and the circuit chip 20. Here, a predetermined number of pixel columns are vertically cut out from the two-dimensional arranged pixel region 11 of the pixel chip 10, and the circuit group in the AD converter circuit region 21 corresponding to these pixel columns is referred to as a repeater 30. In this example, the circuit group corresponding to pixel columns having a width of four pixels is shown as a repeater 30.

Further, the repeater 30 is divided by a predetermined row, and the divisional portions are referred to as clusters 31. In this example, the circuit group corresponding to pixels 12 of eight rows with the width of four pixels is shown as a cluster 31. That is, the circuit group in the AD converter circuit region 21 is designed as a plurality of clusters 31 arranged in a two-dimensional manner.

Further, in the cluster 31, circuits for the number of tone levels are provided for one pixel. That is, circuits corresponding to the bit depth required for expressing the tone levels are provided. Furthermore, redundant circuits may be provided in case of failure an some pixels.

### [Floor Plan]

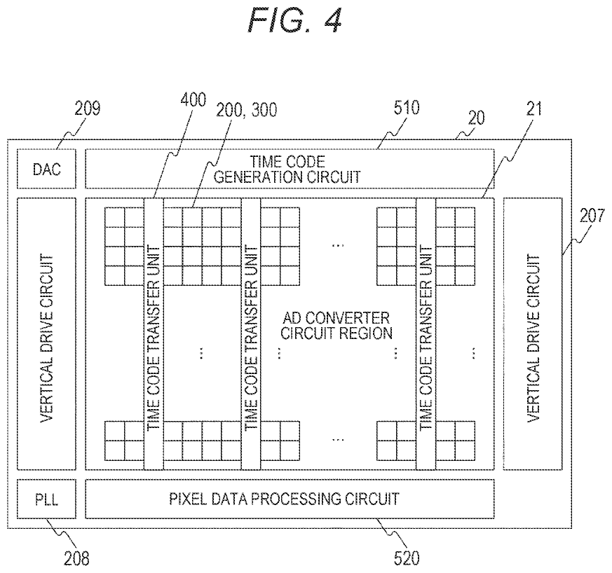

FIG. 4 is a diagram showing an example floor plan of the circuit chic 20 according to the embodiment of the present technology.

As described above, the AD converter circuit region 21 is provided in the central portion of the circuit chip 20. This AD converter circuit region 21 is designed as a plurality of clusters 31 arranged in a two-dimensional manner. A cluster 31 includes an AD converter circuit 200, a memory circuit 300, and a time code transfer unit 400. These components be described later in detail.

Around the AD converter circuit region 21, a vertical drive circuit 207, a phase locked loop (PLL) 208, a digital-to-analog converter (DAC) 209, a time code generation circuit 510, a pixel data processing circuit 520, and the like are disposed as appropriate.

The vertical drive circuit 207 is a circuit that performs vertical driving of each circuit in the AD converter circuit region 21. The PLL 208 is a phase synchronizer circuit for generating a clock signal. The DAC 209 is a circuit that generates a ramp signal RMP to be used for AD conversion of an analog pixel signal into a digital signal. The ramp signal RMP is a slope signal whose level (voltage) decreases monotonically with the passage of time, and is also called a reference signal (a reference voltage signal).

In the time code generation circuit 510, each pixel 12 generates a time code to be used for AD conversion of an analog pixel signal into a digital signal, and supplies the time code to the corresponding time code transfer unit 400. Although riot shown in the drawing, one time code generation circuit 510 is provided for one time code transfer unit 400. However, a plurality of time code transfer units 400 may share one time code generation circuit 510.

The pixel data processing circuit 520 performs predetermined digital signal processing, such as a black level correction process for correcting black level and a correlated double sampling (CDS) process, on digital pixel data as necessary.

### [Repeater]

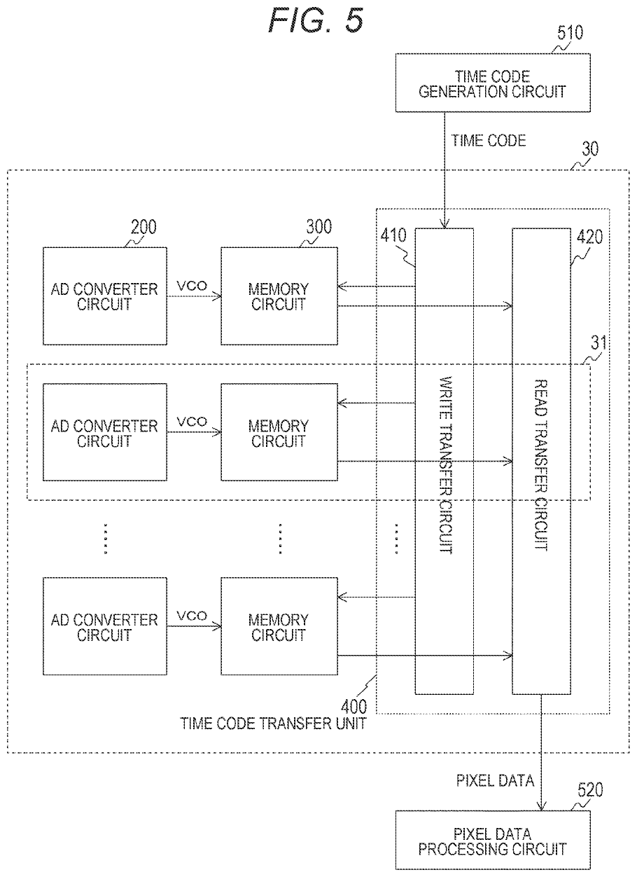

FIG. 5 is a diagram showing an example of a repeater 30 according to the embodiment of the present technology.

As described above, a repeater 30 is a circuit group in the AD converter circuit region 21 corresponding to a predetermined number of pixel columns, and is formed with a plurality of clusters 31 arranged in the column direction. The repeater 30 includes a plurality of AD converter circuits 200 arranged in the column direction, a plurality of memory circuits 300 corresponding to the respective AD converter circuits 200, and a time code transfer unit 400. Further, the time code transfer unit 400 includes a write transfer circuit 410 and a read transfer circuit 420.

An AD converter circuit 200 is a circuit that performs AD conversion on an analog pixel signal from a pixel 12 into digital pixel data.

A memory circuit 300 is a circuit that stores a time code supplied from the write transfer circuit 410, and the digital pixel data subjected to the AD conversion.

The write transfer circuit 410 transfers a time code from the time code generation circuit 510 with a shift register, and supplies the time code to the memory circuit 300 of each cluster 31.

The read transfer circuit 420 transfers digital pixel data output from the memory circuit 300 of each cluster 31 with a shift register, and outputs the digital pixel data to the pixel data processing circuit 520. Note that the read transfer circuit 420 is an example of the transfer unit disclosed in the claims.

### [AD Converter Circuit]

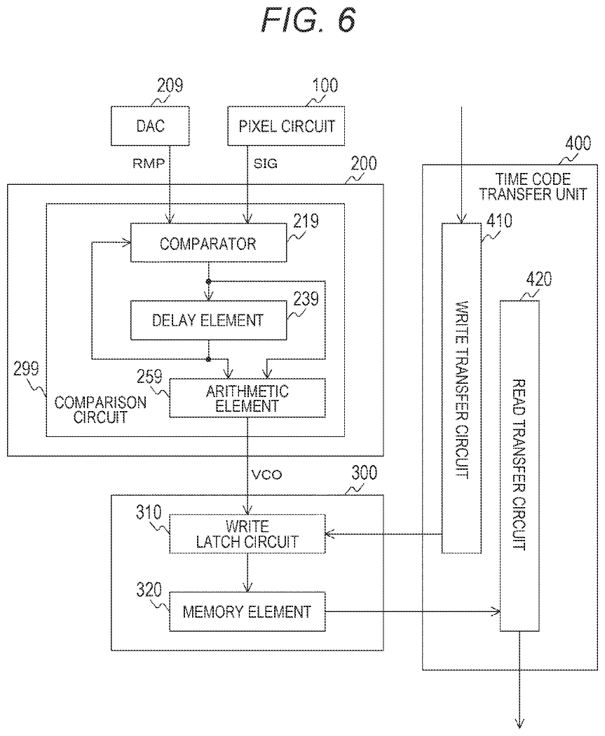

FIG. 6 is a diagram showing an example configuration of an AD converter circuit 200 according to the embodiment of the present technology.

An AD converter circuit 200 includes a comparison circuit 299 that compares an analog pixel signal SIG from a pixel circuit 100 with a ramp signal RMP from the DAC 209, and outputs a comparison result VCO. The comparison circuit 299 includes a comparator 219, a delay element 239, and an arithmetic element 259.

The comparator 219 is a circuit that compares the analog pixel signal SIG with the ramp signal RMP. The delay element 239 is a circuit that delays the output of the comparator 219, and supplies the result to the comparator 219 and the arithmetic element 259. The arithmetic element 259 is a circuit that performs an arithmetic operation on the basis of the output of the comparator 219 and the output of the delay element 239. The specific circuit configuration for forming these circuits will be described later.

The memory circuit 300 includes a write latch circuit 310 and a memory element 320 for reading. The write latch circuit 310 is a latch circuit that holds a time code supplied from the write transfer circuit 410 as pixel data at the time when the comparison result VCO from the comparison circuit 299 is inverted. The memory element 320 stores the pixel data held in the write latch circuit 310, and outputs the pixel data to the read transfer circuit 420 in accordance with read control.

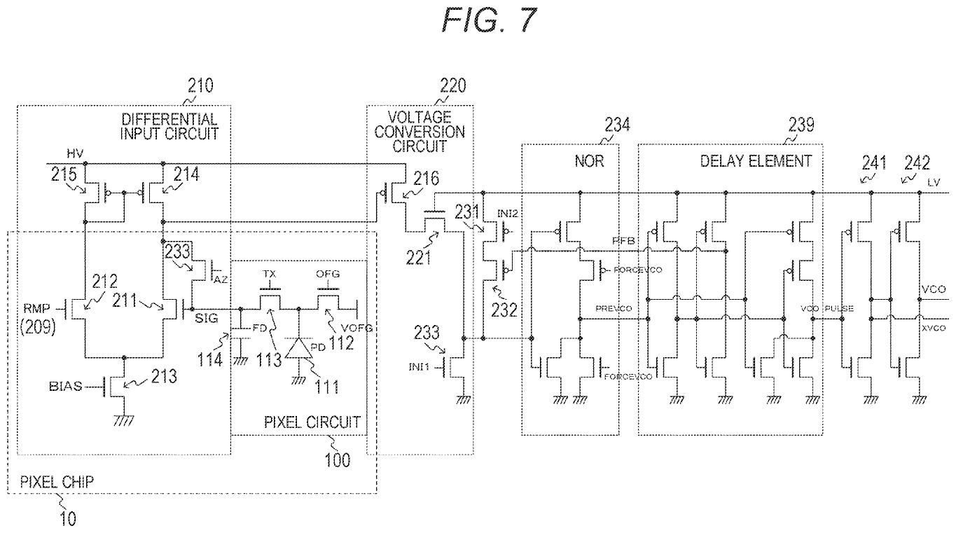

FIG. 7 is a diagram showing an example circuit configuration of an AD converter circuit 200 according to the embodiment of the present technology.

An AD converter circuit 200 includes a differential input circuit 210, a voltage conversion circuit 220, a delay element 239, and the like. An analog pixel signal SIG from the pixel circuit 100 and a ramp signal RMP from the DAC 209 are input to the differential input circuit 210.

The pixel circuit 100 generates an analog signal by photoelectric conversion. This pixel circuit 100 includes a reset transistor 115, a floating diffusion layer 114, a transfer transistor 113, a photodiode 111, and an emission transistor 112, for example. N-type metal-oxide-semiconductor (MOS) transistors are used as the reset transistor 115, the transfer transistor 113, the photodiode 111, and the emission transistor 112, for example.

The photodiode 111 generates electric charge by photoelectric conversion. When instructed to perform emission by a drive signal OFG from the driver, the emission transistor 112 discharges the electric charge from the photodiode 111.

When instructed to perform transfer by a transfer signal TX from the driver, the transfer transistor 113 transfers the electric charge from the photodiode 111 to the floating diffusion layer 114 at the end of the exposure.

The floating diffusion layer 114 generates an analog pixel signal SIG with the voltage corresponding to the amount of the transferred electric charge.

When instructed to perform initialization by a reset signal AZ from the driver, the reset transistor 115 initializes the floating diffusion layer 114.

The differential input circuit 210 includes differential transistors 211 and 212, a current source transistor 213, and P-type transistors 215 and 214.

The differential transistors 211 and 212 amplify the difference between the analog pixel signal SIG and the ramp signal RMP with a constant current, and output the result as a differential amplification signal DIF. For example, N-type MOS transistors are used as these differential transistors 211 and 212. The respective sources of the differential transistors 211 and 212 are both connected to the circuits in the circuit chip 20 via a common node. Further, the gate of the differential transistor 211 is connected to a floating diffusion layer 223, and the gate of the differential transistor 212 is connected to the DAC 209.

The P-type transistors 214 and 215 are connected in parallel to a terminal of a power supply voltage HV. Also, the gate of the P-type transistor 215 is connected to its own drain and the gate of the P-type transistor 214. Further, the drain of the P-type transistor 215 is connected to the drain of the differential transistor 212, and the drain of the P-type transistor 214 is connected to the drain of the differential transistor 211. Also, the gate of a P-type transistor 216 is connected to the drain of the P-type transistor 214, and the drain of the P-type transistor 216 is connected to the voltage conversion circuit 220. The circuit formed with the P-type transistors 214, 215, and 216 functions as a current mirror circuit with the above described connection configuration. The differential amplification signal DIF is output from this current mirror circuit to the voltage conversion circuit 220.

A predetermined bias voltage Vbias is applied to the Gate of the current source transistor 213, and the source of the current source transistor 213 is grounded. This current source transistor 213 functions as a current source that supplies a constant current corresponding to the bias voltage Vbias.

The voltage conversion circuit. 220 converts the voltage of the differential amplification signal DIP supplied from the differential input circuit 210. This voltage conversion circuit 220 includes an N-type transistor 221. For example, a MOS transistor is used as the N-type transistor 221. This N-type transistor 221 is inserted between the differential input circuit 210 and a positive feedback circuit in a later stage, and a power supply voltage 1131 that is lower than the power supply. voltage HV is applied to the gate of the N-type transistor 221.

The positive feedback circuit outputs a positive feedback signal PFB for accelerating inversion transition of the node in the stage before a NOR gate 234. This positive feedback circuit includes P-type transistors 231 and 232, an N-type transistor 233, and the NOR gate 234. For example, MOS transistors are used as the P-type transistor 231, the P-type transistor 232, and the N-type transistor 233.

The P-type transistor 231, the P-type transistor 232, and the N-type transistor 233 are connected in series between a terminal of the power supply voltage LV and a ground terminal. A drive signal INI2 from the driver is input to the gate of the P-type transistor 231, and a drive signal INI1 from the driver is input to the N-type transistor 233.

One of the two input terminals of the NOR gate 234 is connected to connection terminals of the P-type transistor 232 and the N-type transistor 233, and a drive signal FORCEVCO from the driver is input to the other one of the two input terminals. This drive signal FORCEVCO is a signal for forcibly causing inversion in a case where inversion does not occur as a result of comparison between the analog pixel signal SIG and the ramp signal RMP. The output of the NOR gate 234 is output to an inverter 241 via the delay element 239.

The inverter 241 inverts the output of the delay element 239, and outputs the result as a comparison result XVCO to an inverter 242 and the memory circuit 300. The inverter 242 inverts the comparison result XVCO, and outputs the result as a comparison result VCO to the memory circuit 300.

Note that, in this example, the pixel circuit 100 and the differential transistors 211 and 212 are disposed on the pixel chip 10, and the other circuits are disposed on the circuit chip 20.

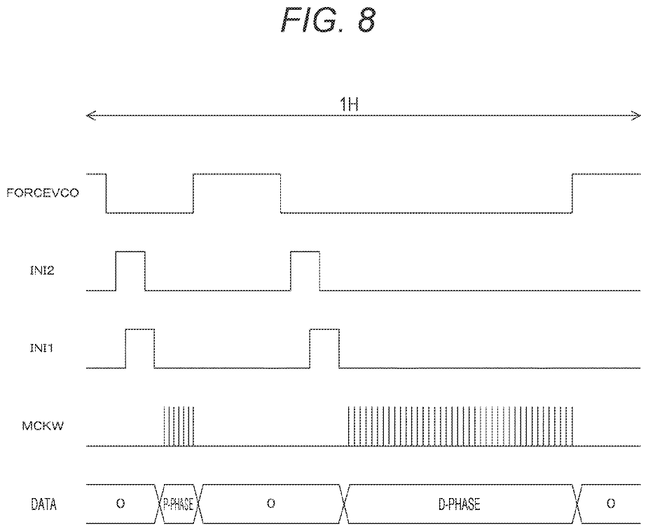

FIG. 8 is a diagram showing an example operation timing of an AD converter circuit 200 according to the embodiment of the present technology.

Here, an example timing of writing into the write latch circuit 310 in one horizontal period is described. When the drive signals INI1 and INI2 are input, P-phase data is written into the write latch circuit 310 in accordance with a clock MCKW of the write transfer circuit 410. This P-phase data turns into reset-level data in the CDS process. When the P-phase period ends, the drive signal FORCEVCO is input, and the comparison result of the entire pixel in the horizontal direction is once inverted.

After that, when the drive signals INI1 and INI2 are input, D-phase data is written into the write latch circuit 310 in accordance with the clock MCKW of the write transfer circuit 410. This D-phase data turns into signal-level data in the CDS process. When the D-phase period ends, the drive signal FORCEVCO is input, and the comparison result of the entire pixel in the horizontal direction is once inverted, so that writing in the next horizontal period is awaited.

### [Circuit Configuration of a Cluster]

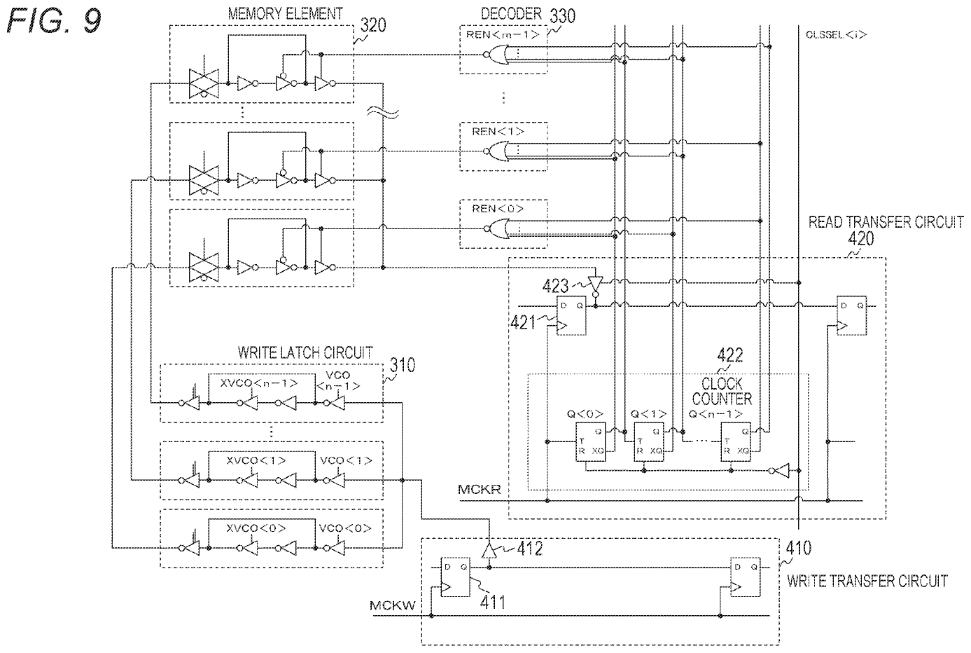

FIG. 9 is a diagram showing an example circuit configuration of a cluster according to the embodiment of the present technology.

The write transfer circuit 410 includes a shift register formed with a plurality of registers 411, and sequentially transfers time codes from the time code generation circuit 510 to the registers 411 in a later stage, in accordance with the clock MCKW. A plurality of write latch circuits 310 is connected to the respective registers 411 via a buffer 412, and the rime codes held in the registers 411 are sequentially supplied to the write latch circuits 310.

Comparison results VCO <n-1:0> and XVCO <n-1:0> are supplied from the AD converter circuits 200 to the plurality of write latch circuits 310. The write latch circuits 310 hold the time codes supplied from the registers 411 at the time when the comparison results are inverted. The time codes held in the plurality of write latch circuits 310 are supplied to the corresponding memory elements 320, and are stored as pixel data.

The plurality of memory elements 320 reads out the stored contents in accordance with control signals REN <m-1:0> supplied from a plurality of corresponding decoders 330. The pixel data read from the memory elements 320 is output to the read transfer circuit 420.

The read transfer circuit 420 includes a shift register formed with a plurality of registers 421, and sequentially transfers the held pixel data to the registers 421 in a later in accordance with a clock MCKR.

In this embodiment, a clock counter 422 is provided, and the clock counter 422 sequentially outputs count values Q <n-1:0> in synchronization with the same clock MCKR as that for the registers 421. The count values of the clock counter 422 are supplied to the plurality of decoders 330. Each of the plurality of decoders 330 decodes the count value from the clock counter 422, and performs control to read the stored contents from the corresponding memory element 320 when detecting that that the count value has reached a predetermined value.

Note that the circuit configuration is not specifically explained in this example, but a noise removal circuit, a time code conversion circuit, and the like may also be included as other circuit components, for example.

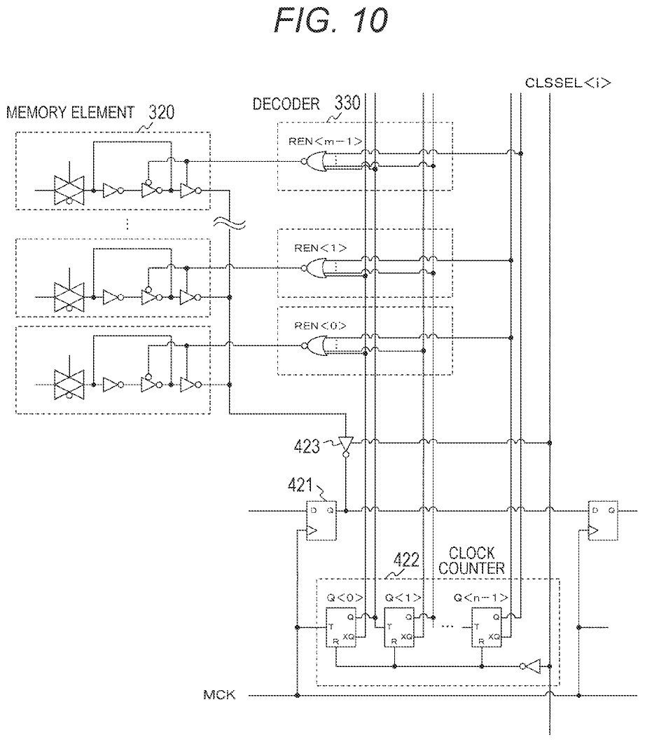

FIG. 10 is a diagram showing an example circuit configuration related to cluster reading in the first embodiment of the present technology. This example circuit configuration mainly shows the circuit portion related to reading in the example circuit configuration of the cluster described above. Note that the clock NCKR will be hereinafter referred to as the clock MCK.

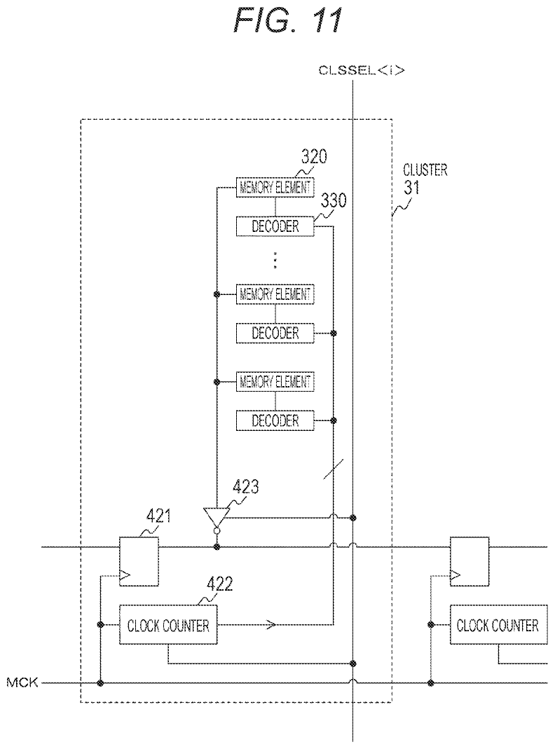

FIG. 11 is a diagram showing an example block configuration related to reading in a cluster according to the first embodiment of the present technology.

A plurality of memory elements 320 connected to one register 421 of the read transfer circuit 420 constitutes one cluster 31. A plurality of decoders 330 is provided for the respective memory elements 320. A clock counter 422 that sequentially outputs count values in synchronization with the clock MCK is connected to the plurality of decoders 330. Note that the clock counter 422 is an example of the counter disclosed in the claims.

Each of the plurality of decoders 330 decodes a count value from the clock counter 422, and performs control to read the stored contents from the corresponding memory element 320 when detecting that that the count value has reached a predetermined value. The plurality of decoders 330 detects different values from one another as the predetermined value. As a result, one of the plurality of memory elements 320 exclusively outputs pixel data to the read transfer circuit 420.

A cluster selection signal CLSSEL<i> is supplied to a cluster #i. This cluster selection signal CLSSEL<i> is valid only when the cluster #i is selected. This cluster selection signal CLSSEL<i> is input to the control terminal of an output buffer 423, and the pixel data from the plurality of memory elements 320 in the cluster #i is output to the read transfer circuit 420 only when the cluster #i is selected. Note that the output buffer 423 is an example of the output unit disclosed in the clams.

Further, this cluster selection signal CLSSEL<i> is input to the reset terminal of the clock counter 422, and counting is performed only when the cluster #i is selected. That is, when the cluster selection signal CLSSEL<i> switches to a valid state, counting is started from the initial value.

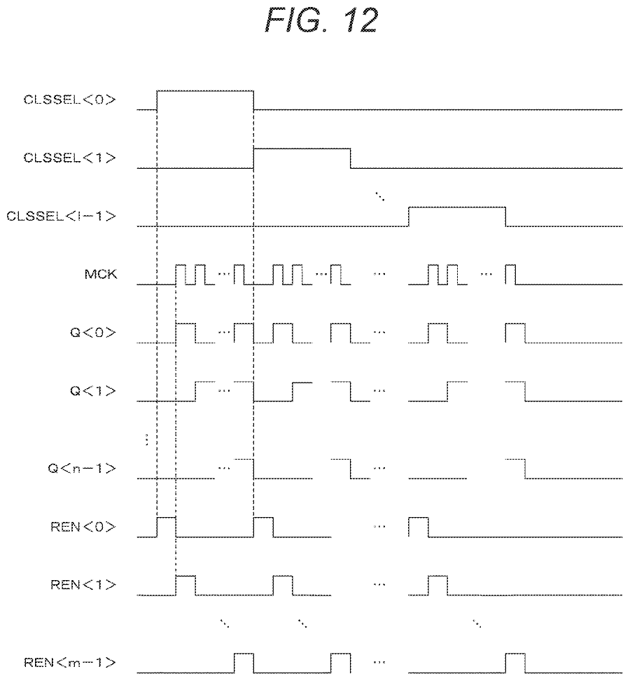

FIG. 12 is a diagram showing an example timing of an operation related to reading in a cluster according to the embodiment of the present technology.

The cluster selection signal CLSSEL<i> becomes valid sequentially, so that reading in the selected cluster is performed. In the selected cluster, the clock counter 422 starts counting, and count values Q <n-1:0> are sequentially output in synchronization with the clock MCK.

Each of the plurality of decoders 330 decodes a count value Q <n-1:0> of the clock counter 422, to generate a control signal REM <m-1:0>. The plurality, of memory elements 320 reads out the stored contents in accordance with control signals REM <m-1:0> supplied from corresponding decoders 330. The pixel data read from the memory elements 320 is output to the read transfer circuit 420.

### [Read Access Image]

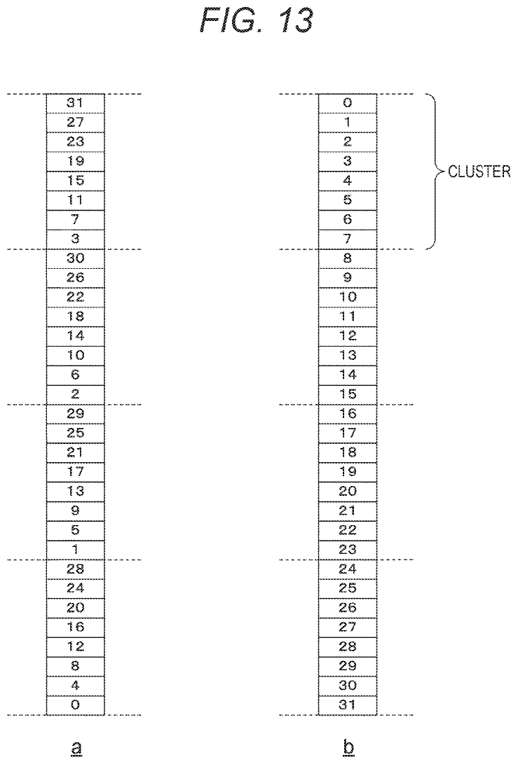

FIG. 13 is a diagram showing an example of a read

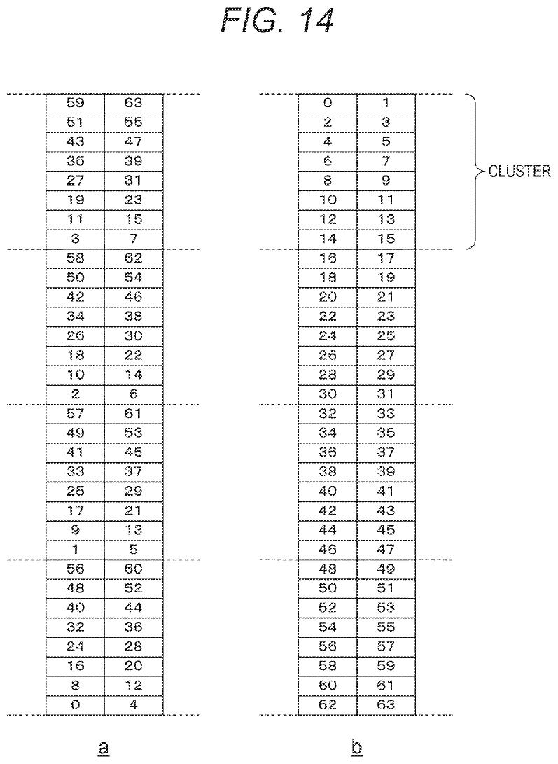

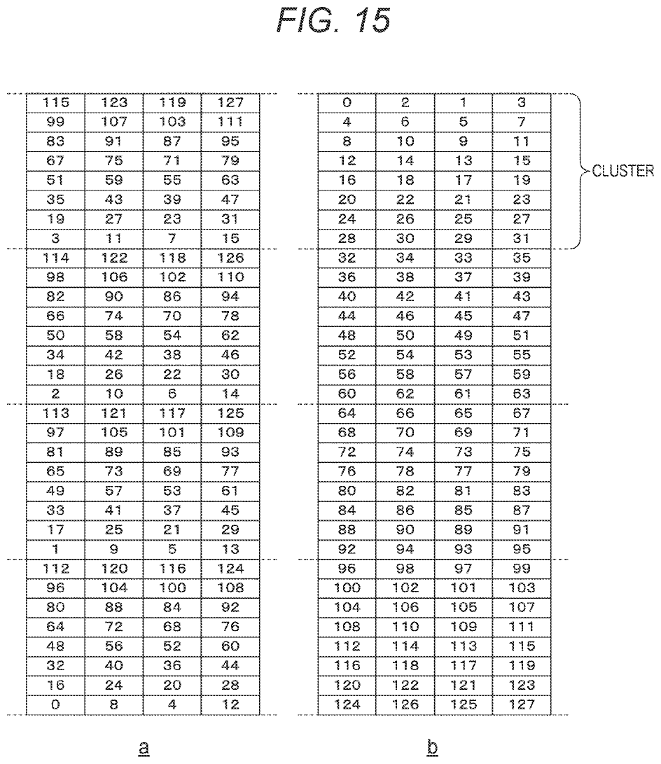

access image in a case where the width of a repeater 30 in the embodiment of the present technology is one pixel column. FIG. 14 is a diagram showing an example of a read access image in a case where the width of a repeater 30 in the embodiment of the present technology is two pixel columns. FIG. 15 is a diagram showing an example of a read access image in a case where the width of a repeater 30 in the embodiment of the present technology is four pixel columns.

As shown in a of the drawings, during a read access in a case where any decoder is not used, the pixel data at the same address in the clusters is sequentially read out. Therefore, to output pixel data while maintaining the pixel sequence, it is necessary to hold the pixel data of the entire frame in a frame memory and perform rearrangement.

In this embodiment, on the other hand, the decoders 330 are provided so that reading in the respective clusters can be performed in a desired order, as shown in b of the drawings. As a result, even when pixel data is output while the pixel sequence is maintained, the pixel data can be sequentially output only with a line memory.

### [Control Wiring Image]

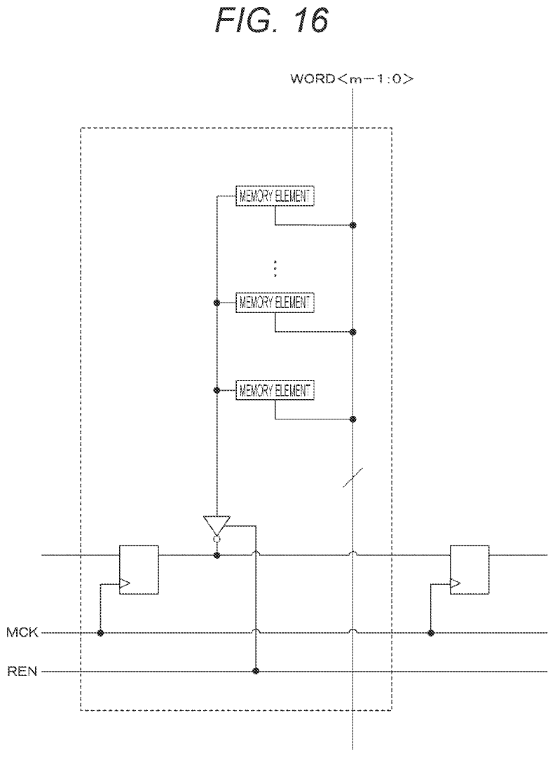

FIG. 16 is a diagram showing a cluster configuration expected in a case where any decoder is not used.

In a case where any decoder is not used, a word selection signal WORD <m-1:0> for selecting each word of the memory elements is distributed globally. As a result, the stored contents are output from the memory element selected by the word selection signal WORD <m-1:0>. The stored contents output from the memory element are then supplied to the register in a later stage via a buffer at the time designated by the control signal REN.

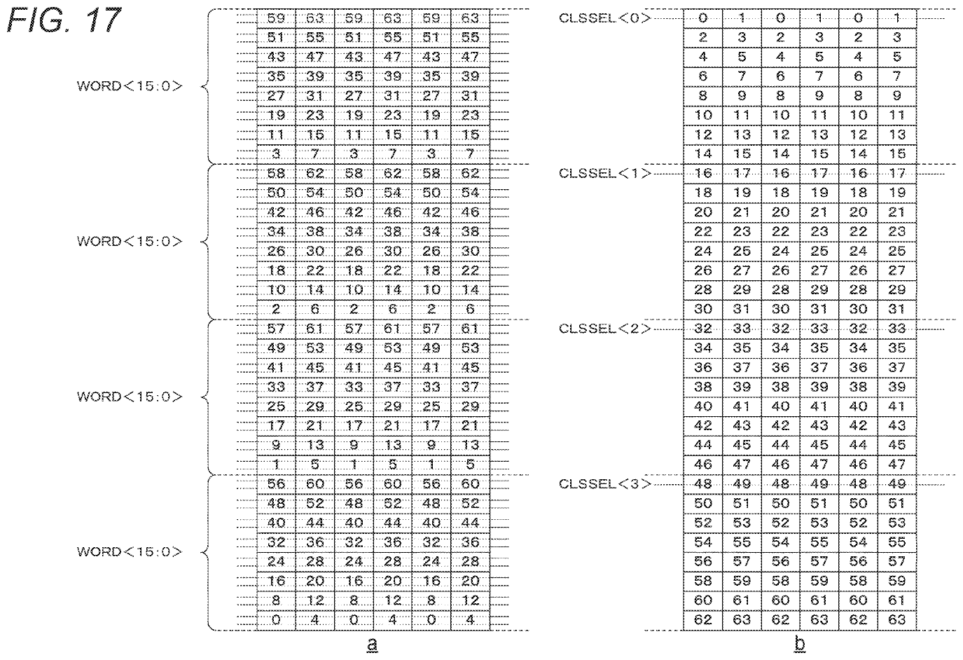

FIG. 17 is a diagram showing a comparative example of a control wiring image.

in a case where any decoder is not used, the word selection signal WORD <m-1:0> for selecting each word of the memory elements is globally distributed, as shown in a of the drawing, and each of the memory elements performs a read operation in accordance with the word selection signal WORD <m-1:0>.

In this embodiment, on the other hand, it is only required to supply one cluster selection signal CLSSEL<i> to each cluster, as shown in b of the drawing, and the wiring line for the signal for selecting a memory element 320 is a short line from the clock counter 422 to the decoder 330.

That is, in a case where any decoder is not used, it is necessary to globally distribute the word selection signal WORD <m-1:0> to the memory elements, and this might limit the chip area. Further, the order of reading from the memory elements is fixed by the physical layout. Therefore, to change the order of output, it is necessary to temporarily hold data in a frame buffer and then output the data.

As described above, according to the first embodiment of the present technology, the plurality of decoders 330 corresponding to the respective memory elements 320 is provided in each cluster 31, and the count values from the clock counter 422 are decoded, so that reading can be performed in a desired order. Further, since it is not necessary to globally distribute the selection signal to the memory elements 320, the chip area can be efficiently used.

### 2. Second Embodiment

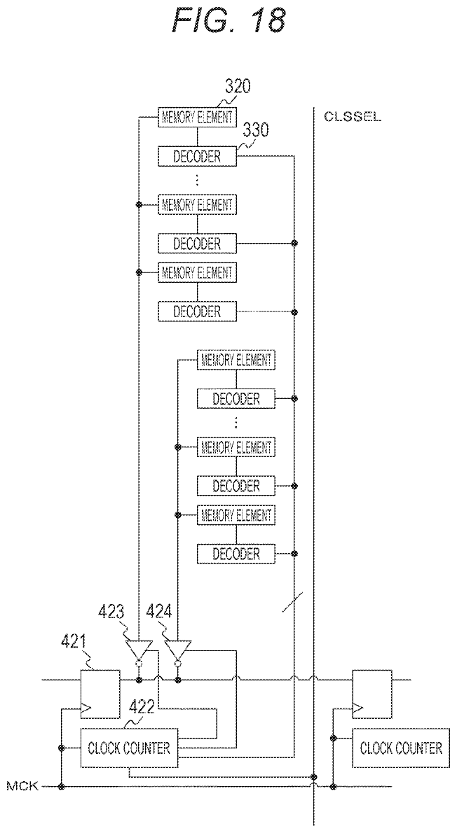

FIG. 18 is a diagram showing an example block configuration related to reading in a cluster according to a second embodiment of the present technology.

In the first embodiment described above, outputs from the memory elements 320 are supplied to the register 421 of the next stage via one output buffer 423. However, a plurality of output buffers may be provided. In the example to be described in the second embodiment, two output buffers 423 and 424 are used. However, three or more output buffers may be used. Note that the output buffers 423 and 424 are an example of the plurality of output circuits disclosed in the claims.

In the second embodiment, the pairs of a memory element 320 and a decoder 330 in a cluster are divided into two groups, and outputs thereof are supplied to the register 421 of the next stage via the different output buffers 423 and 424, respectively. As the pairs are divided in this manner, the memory elements 320 and the decoders 330 can be arranged independently.

Some bits (the most significant bits, for example) of count values are input from the clock counter 422 to the output buffers 423 and 424. As a result, the output buffers 423 and 424 can output data exclusively of each other, so that a collision on the signal line to the register 421 of the next stage can be avoided.

As described above, according to the second. embodiment of the present technology, the plurality of output buffers 423 and 424 is used, so that the pairs of a memory element 320 and a decoder 330 can be divided and be flexibly arranged in a cluster.

### 3. Third Embodiment

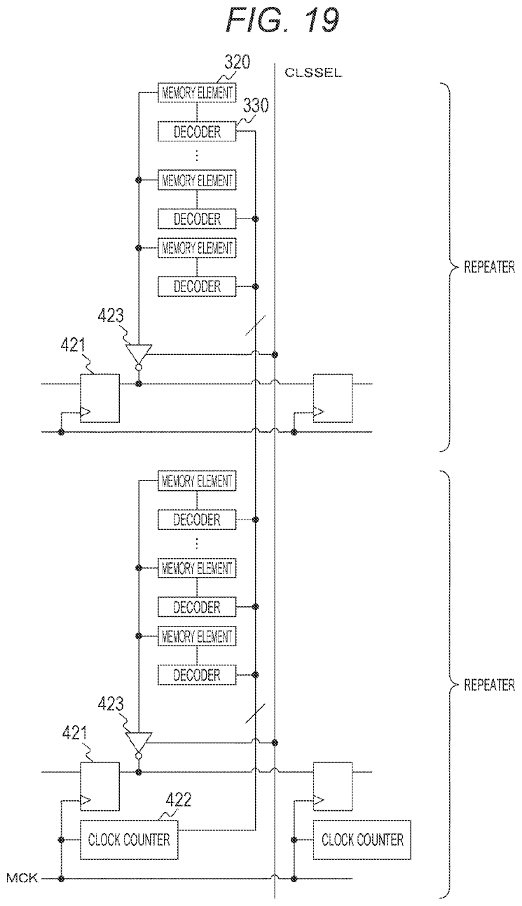

FIG. 19 is a diagram showing an example block configuration related to reading in a cluster according to a third embodiment of the present technology.

In the third embodiment, a clock counter 422 is shared between clusters of adjacent repeaters. That is, in the first embodiment described above, the clock counters 422 are provided independently for the plurality of memory elements 320 connected to the different registers 421. In the third embodiment, on The other hand, one clock counter 422 is shared between clusters of adjacent repeaters.

The same cluster selection signal CLSSEL is referred to by clusters adjacent to each other in the row direction. Accordingly the clusters sharing a clock counter 422 operate at the same timing. However, as the memory elements 320 of different clusters are connected to different registers 421, no collisions occur on the signal line to the registers 421 of the next stage.

As described above, according to the third embodiment of the present technology, a clock counter 422 is shared between clusters of adjacent repeaters. Thus, the hardware resources in the chip can be saved.

### 4. Fourth Embodiment

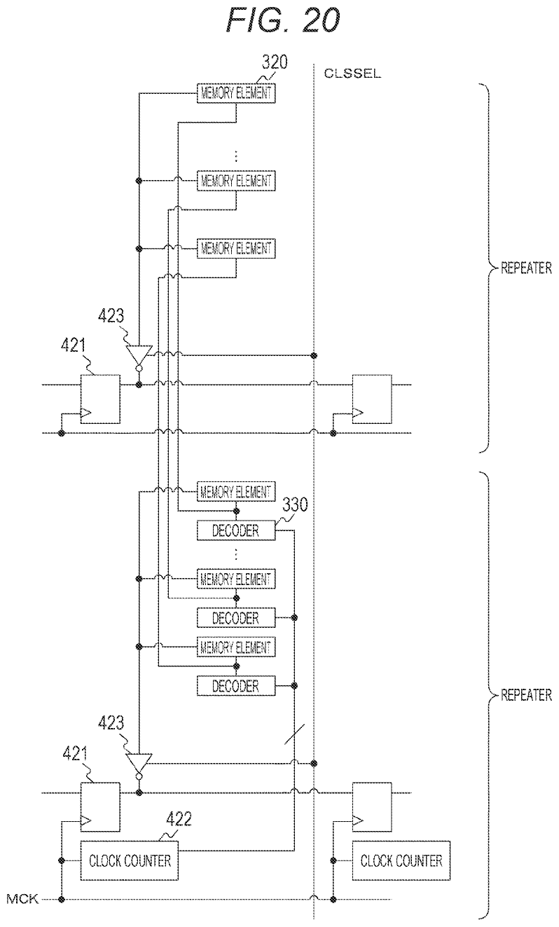

FIG. 20 is a diagram showing an example block configuration related to reading in a cluster according to a fourth embodiment of the present technology.

In this fourth embodiment, a clock counter 422 and decoders 330 are shared between clusters of adjacent repeaters. That is, in the third embodiment described above, a clock counter 422 is shared between clusters of adjacent repeaters. In the fourth embodiment, on the other hand, a plurality of decoders 330 is further shared between clusters of adjacent repeaters.

The same cluster selection signal CLSSEL is referred to by clusters of clusters adjacent to each other in the row direction, but collisions on the signal line to the registers 421 of the next stage are avoided as in the third embodiment described above.

As described above, according to the fourth embodiment of the present technology, a clock counter 422 and a plurality of decoders 330 are shared between clusters of adjacent repeaters. Thus, the hardware resources in the chip can be saved.

### 5. Fifth Embodiment

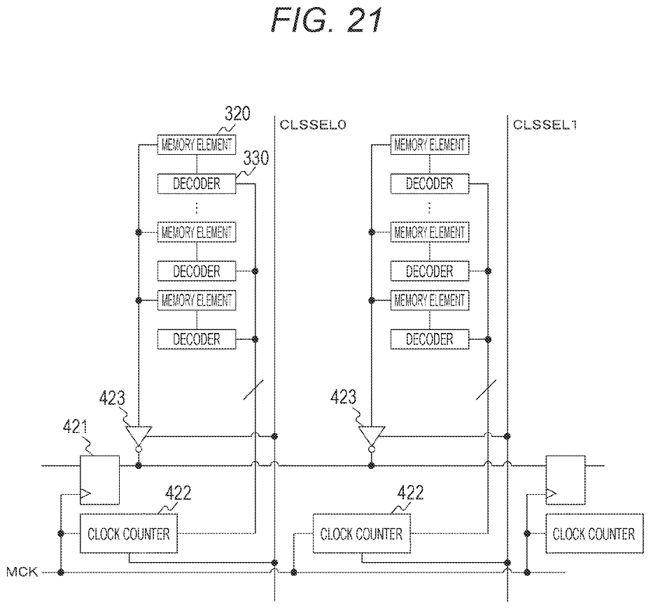

FIG. 21 is a diagram showing an example block configuration related to reading in a cluster according to a fifth embodiment of the present technology.

In the embodiments described above, one clock counter 422 is provided for one cluster. In a configuration according to the fifth embodiment, on the other hand, a plurality of clock counters 422 is provided for one cluster. As a result, the number of decoders 330 connected to one clock counter 422 can be reduced. Thus, the bit width of a signal line that supplies clock values can be made smaller. Further, the memory elements 320 and the decoders 330 connected to a clock counter 422 can be provided independently of those connected to the other clock counters 422.

In the fifth embodiment, it is necessary to supply a cluster selection signal CLSSEL0 or CLSSEL1 separately for each clock counter 422. In this regard, the memory elements 320 and the decoder 330 connected to different clock counters 422 may be defined as different clusters.

As described above, according to the fifth embodiment of the present technology, a plurality of clock counters 422 is provided for one cluster, so that the bit width of each clock counter 422 can be made smaller. Further, the sets of a memory element 320 and decoders 330 can be divided and be flexibly arranged in a cluster.

### 6. Example Application to an endoscopic Surgery System

The technology (the present technology) according to the present disclosure can be applied to various products. For example, the technology according to the present disclosure may be applied to an endoscopic surgery system.

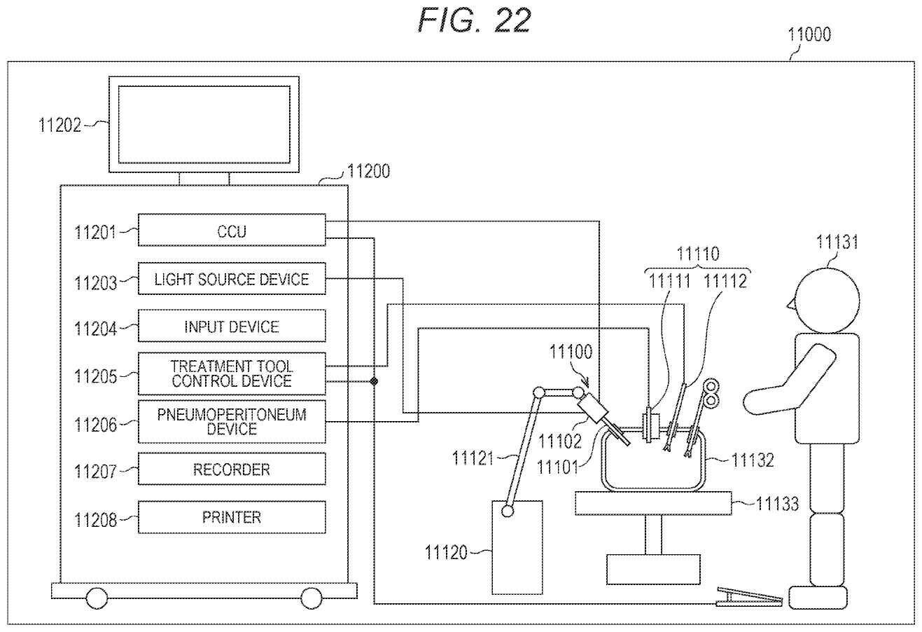

FIG. 22 is a diagram schematically showing an example configuration of an endoscopic surgery system to which the technology (the present technology) according to the present disclosure can be applied.

FIG. 22 shows a situation where a surgeon (a physician) 11131 is performing surgery on a patient 11132 on a patient bed 11133, using an endoscopic surgery system 11000. As shown in the drawing, the endoscopic surgery system 11000 includes an endoscope 11100, other surgical tools 11110 such as a pneumoperitoneum tube 11111 and an energy treatment tool 11112, a support arm device 11120 that supports the endoscope 11100, and a cart 11200 on which various kinds of devices for endoscopic surgery are mounted.

The endoscope 11100 includes a lens barrel 11101 that has a region of a predetermined length from the top end to be inserted into a body cavity of the patient 11132, and a camera head 11102 connected to the base end of the lens barrel 11101. In the example shown in the drawing, the endoscope 11100 is designed as a so-called rigid scope having a rigid lens barrel 11101. However, the endoscope 11100 may be designed as a so-called flexible scope having a flexible lens barrel.

At the top end of the lens barrel 11101, an opening into which an objective lens is inserted is provided. A light source device 11203 is connected to the endoscope 11100, and the light generated by the light source device 11203 is guided to the top end of the lens barrel by a light guide extending inside the lens barrel 11101, and is emitted toward the current observation target in the body cavity of the patient 11132 via the objective lens. Note that the endoscope 11100 may be a forward-viewing endoscope, an oblique-viewing endoscope, or a side-viewing endoscope.

An optical system and imaging devices are provided inside the camera head 11102, and reflected light (observation light) from the current observation target is converged on the imaging devices by the optical system. The observation light is photoelectrically converted by the imaging devices, and an electrical signal corresponding to the observation light, or an image signal corresponding to the observation image, is generated. The image signal is transmitted as RAW data to a camera control unit (CCU) 11201.

The CCU 11201 is formed with a central processing unit (CPU), a graphics processing unit (GPU) , or the like, and collectively controls operations of the endoscope 11100 and a display device 11202. Further, the CCU 11201 receives an image signal from the camera head 11102, and subjects the image signal to various kinds of image processing, such as a development process (a demosaicing process), for example, to display an image based on the image signal.

Under the control of the CCU 11201, the display device 11202 displays an image based on the image signal subjected to the image processing by the CCU 11201.

The light source device 11203 is formed with a light source such as a light emitting diode (LED), for example, and supplies the endoscope 11100 with illuminating light for imaging the surgical site or the like.

An input device 11204 is an input interface to the endoscopic surgery system 11000. The user can input various kinds of information and instructions to the endoscopic surgery system 11000 via the input device 11204. For example, the user inputs an instruction or the like to change imaging conditions (such as the type of illuminating light, the magnification, and the focal length) for the endoscope 11100.

A treatment tool control device 11205 controls driving of the energy treatment tool 11112 for tissue cauterization, incision, blood vessel sealing, or the like. A pneumoperitoneum device 11206 injects a gas into a body cavity of the patient 11132 via the pneumoperitoneum tube 11111 to inflate the body cavity, for the purpose of securing the field of view of the endoscope 11100 and the working space of the surgeon. A recorder 11207 is a device capable of recording various kinds of information about the surgery. A printer 11208 is a device capable of printing various kinds of information relating to the surgery in various formats such as text, images, graphics, and the like.

Note that the light source device 11203 that supplies the endoscope 11100 with the illuminating light for imaging the surgical site can be formed with an LED, a laser light source, or a white light source that is a combination of an LED and a laser light source, for example. In a case where a white light source is formed with a combination of RGB laser light sources, the output intensity and the output timing of each color (each wavelength) can be controlled with high precision. Accordingly, the white balance of an image captured by the light source device 11203 can be adjusted. Alternatively, in this case, laser light from each of the RGB laser light sources may be emitted onto the current observation target in a time-division manner, and driving of the imaging devices of the camera head 11102 may be controlled in synchronization with the timing of the light emission. Thus, images corresponding to the respective RGB colors can be captured in a time-division manner. According to the method, a color image can be obtained without any color filter provided in the imaging devices.

Further, the driving of the light source device 11203 may also be controlled so that the intensity of light to be output is changed at predetermined time intervals. The driving of the imaging devices of the camera head 11102 is controlled in synchronism with the timing of the change in the intensity of the light, and images are acquired in a time-division manner and are then combined. Thus, a high dynamic range image with no black portions and no white spots can be generated.

Further, the light source device 11203 may also be designed to be capable of supplying light of a predetermined wavelength band compatible with special light observation. In special light observation, light of a narrower band than the illuminating light (or white light) at the time of normal observation is emitted, with the wavelength dependence of light absorption in body tissue being taken advantage of, for example. As a result, so-called narrow band light observation (narrow band imaging) is performed to image predetermined tissue such as a blood vessel in a mucosal surface layer or the like, with high contrast. Alternatively, in the special light observation, fluorescence observation for obtaining an image with fluorescence generated through emission of excitation light may be performed. In fluorescence observation, excitation light is emitted to body tissue so that the fluorescence from the body tissue can be observed (autofluorescence observation). Alternative a reagent such as indocyanine green (ICG) is locally injected into body tissue, and excitation light corresponding to the fluorescence wavelength of the reagent is emitted to the body tissue so that a fluorescent image can be obtained, for example. The light source device 11203 can be designed to be capable of supplying narrow band light and/or excitation light compatible with such special light observation.

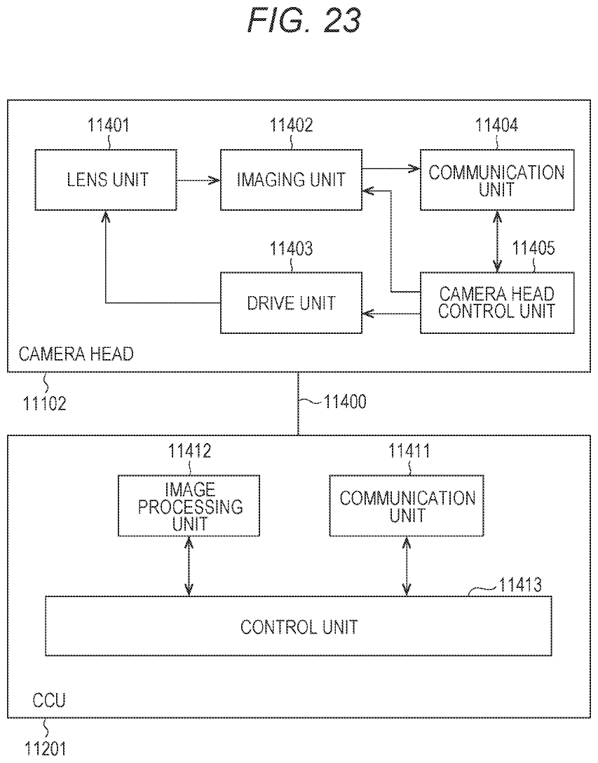

FIG. 23 is a block diagram showing an example of the functional configurations of the camera head 11102 and the CCU 11201 shown in FIG. 22.

The camera head 11102 includes a lens unit 11401, an imaging unit 11402, a drive unit 11403, a communication unit 11404, and a camera head control unit 11405. The CCU 11201 includes a communication unit 11411, an image processing unit 11412, and a control unit 11413. The camera head 11102 and the CCU 11201 are communicably connected to each other by a transmission cable 11400.

The lens unit 11401 is an optical system provided at the connecting portion with the lens barrel 11101. Observation light captured from the top end of the lens barrel 11101 is guided to the camera head 11102, and enters the lens unit 11401. The lens unit 11401 is formed with a combination of a plurality of lenses including a zoom lens and a focus lens.

The imaging unit 11402 may be formed with one imaging device (a so-called single-plate type), or may be formed with a plurality of imaging devices (a so-called multiple-plate type). In a case where the imaging unit 11402 is of a multiple-plate type, for example, image signals corresponding to the respective RGB colors may be generated by the respective imaging devices, and be then combined to obtain a color image. Alternatively, the imaging unit 11402 may be designed to include a pair of imaging devices for acquiring right-eye and left-eye image signals compatible with three-dimensional (3D) display. As the 3D display is conducted, the surgeon 11131 can grasp more accurately the depth of the body tissue at the surgical site. Note that, in a case where the imaging unit 11402 is of a multiple-plate type, a plurality of lens units 11401 is provided for the respective imaging devices.

Further, the imaging unit 11402 is not necessarily provided in the camera head 11102. For example, the imaging unit 11402 may be provided immediately behind the objective lens in the lens barrel 11101.

The drive unit 11403 is formed with an actuator, and, under the control of the camera head control unit 11405, moves the zoom lens and the focus lens of the lens unit 11401 by a predetermined distance along the optical axis. With this arrangement, the magnification and the focal point of the image captured by the imaging unit 11402 can be adjusted as appropriate.

The communication unit 11404 is formed with a communication device for transmitting and receiving various kinds of information to and from the CCU 11201. The communication unit 11404 transmits the image signal obtained as RAW data from the imaging unit 11402 to the CCU 11201 via the transmission cable 11400.

The communication unit 11404 also receives a control signal for controlling the driving of the camera head 11102 from the CCU 11201, and supplies the control signal to the camera head control unit 11405. The control signal includes information about imaging conditions, such as information for specifying the frame rate of captured images, information for specifying the exposure value at the time of imaging, and/or information for specifying the magnification and the focal point of captured images, for example.

Note that the above imaging conditions such as the frame rate, the exposure value, the magnification, and the focal point may be appropriately specified by the user, or may be automatically set by the control unit 11413 of the CCU 11201 on the basis of an acquired image signal. In the latter case, the endoscope 11100 has a so-called auto-exposure (AE) function, an auto-focus (AF) function, and an auto-white-balance (AWB) function.

The camera head control unit 11405 controls the driving of the camera head 11102, on the basis of a control signal received from the CCU 11201 via the communication unit 11404.

The communication unit 11411 is formed with a communication device for transmitting and receiving various kinds of information to and from the camera head 11102. The communication unit 11411 receives an image signal transmitted from the camera head 11102 via the transmission cable 11400.

Further, the communication unit 11411 also transmits a control signal for controlling the driving of the camera head 11102, to the camera head 11102. The image signal and the control signal can be transmitted through electrical communication, optical communication, or the like.

The image processing unit 11412 performs various kinds of image processing on an image signal that is RAW data transmitted from the camera head 11102.

The control unit 11413 performs various kinds of control relating to display of an image of the surgical portion or the like captured by the endoscope 11100, and a captured image obtained through imaging of the surgical site or the like. For example, the control unit 11413 generates a control signal for controlling the driving of the camera head 11102.

Further, the control unit 11413 also causes the display device 11202 to display a captured image showing the surgical site or the like, on the basis of the image signal subjected to the image processing by the image processing unit 11412. In doing so, the control unit 11413 may recognize the respective objects shown in the captured image, using various image recognition techniques. For example, the control unit 11413 can detect the shape, the color, and the like of the edges of an object shown in the captured image, to recognize the surgical tool such as forceps, a specific body site, bleeding, the mist at the time of use of the energy treatment tool 11112, and the like. When causing the display device 11202 to display the captured image, the control unit 11413 may cause the display device 11202 to superimpose various kinds of surgery aid information on the image of the surgical site on the display, using the recognition result. As the surgery aid information is superimposed and displayed, and thus, is presented to the surgeon 11131, it becomes possible to reduce the burden on the surgeon 11131, and enable the surgeon 11131 to proceed with the surgery in a reliable manner.

The transmission cable 11400 connecting the camera head 11102 and the CCU 11201 is an electrical signal cable compatible with electric signal communication, an optical fiber compatible with optical communication, or a composite cable thereof.

Here, in the example shown in the drawing, communication is performed in a wired manner using the transmission cable 11400. However, communication between the camera head 11102 and the CCU 11201 may be performed in a wireless manner.

An example of an endoscopic surgery system to which the technique according to the present disclosure can be applied has been described above. The technology according to the present disclosure can be applied to the imaging unit 11402 in the above described configuration. Specifically, reading in the imaging unit 11402 can be performed in a desired order.

Note that the endoscopic surgery system has been described as an example herein, but the technology according to the present disclosure may be applied to a microscopic surgery system or the like, for example.

### 7. Example Applications to Mobile Structures

The technology (the present technology) according to the present disclosure can be applied to various products. For example, the technology according to the present disclosure may be embodied as a device mounted on any type of mobile structure, such as an automobile, an electrical vehicle, a hybrid electrical vehicle, a motorcycle, a bicycle, a personal mobility device, an airplane, a drone, a vessel, or a robot.

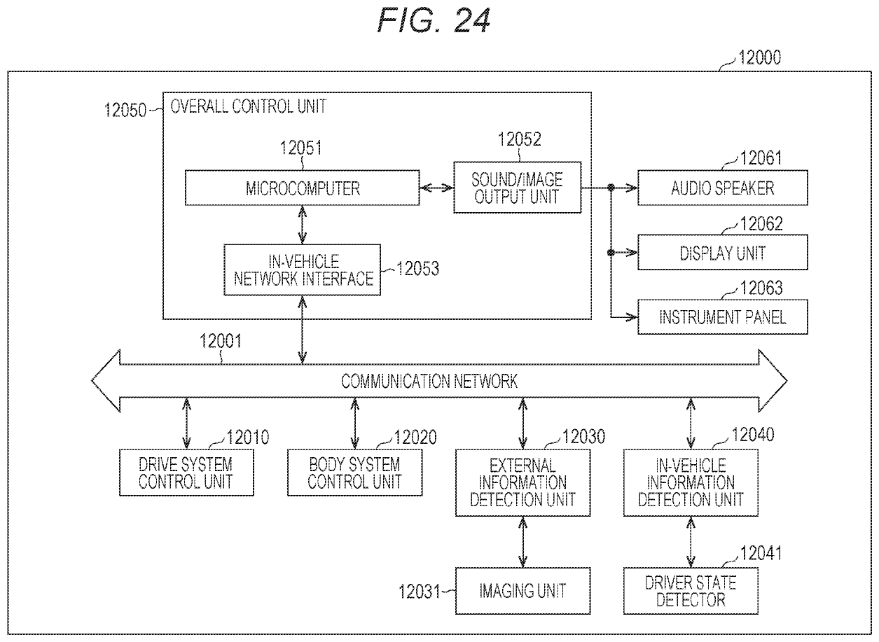

FIG. 24 is a block diagram schematically showing an example configuration of a vehicle control system that is an example of a mobile structure control system to which the technology according to the present disclosure can be applied.

A vehicle control system 12000 includes a plurality of electronic control units connected via a communication network 12001. In the example shown in FIG. 24, the vehicle control system 12000 includes a drive system control unit 12010, a body system control unit 12020, an external information detection unit 12030, an in-vehicle information detection unit 12040, and an overall control unit 12050. Further, a microcomputer 12051, a sound/image output unit 12052, and an in-vehicle network interface (I/F) 12053 are also shown as the functional components of the overall control unit 12050.

The drive system control unit 12010 controls operations of the devices related to the drive system of the vehicle according to various programs. For example, the drive system control unit 12010 functions as control devices such as a driving force generation device for generating a driving force of the vehicle such as an internal combustion engine or a driving motor, a driving force transmission mechanism for transmitting the driving force to the wheels, a steering mechanism for adjusting the steering angle of the vehicle, and a braking device for generating a braking force of the vehicle.

The body system control unit 12020 controls operations of the various devices mounted on the vehicle body according to various programs. For example, the body system control unit 12020 functions as a keyless entry system, a smart key system, a power window device, or a control device for various lamps such as a headlamp, a backup lamp, a brake lamp, a turn signal lamp, a fog lamp, or the like. In this case, the body system control unit 12020 can receive radio waves transmitted from a portable device that substitutes for a key, or signals from various switches. The body system control unit 12020 receives inputs of these radio waves or signals, and controls the door lock device, the power window device, the lamps, and the like of the vehicle.

The external information detection unit 12030 detects information outside the vehicle equipped with the vehicle control system 12000. For example, an imaging unit 12031 is connected to the external information detection unit 12030. The external information detection unit 12030 causes the imaging unit 12031 to capture an image of the outside of the vehicle, and receives the captured image. On the basis of the received image, the external information detection unit 12030 may perform an object detection process for detecting a person, a vehicle, an obstacle, a sign, characters on the road surface, or the like, or perform a distance detection process.

The imaging unit 12031 is an optical sensor that receives light, and outputs an electrical signal corresponding to the amount of received light. The imaging unit 12031 can output an electrical signal as an image, or output an electrical signal as distance measurement information. Further, the light to be received by the imaging unit 12031 may be visible light, or may be invisible light such as infrared rays.

The in-vehicle information detection unit 12040 detects information about the inside of the vehicle. For example, a driver state detector 12041 that detects the state of the driver is connected to the in-vehicle information detection unit 12040. The driver state detector 12041 includes a camera that captures an image of the driver, for example, and, on the basis of detected information input from the driver state detector 12041, the in-vehicle information detection unit 12040 may calculate the degree of fatigue or the degree of concentration of the driver, or determine whether or not the driver is dozing off.

On the basis of the external/internal information. acquired by the external information detection unit 12030 or the in-vehicle information detection unit 12040, the microcomputer 12051 can calculate the control target value of the driving force generation device, the steering mechanism, or the braking device, and output a control command to the drive system control unit 12010. For example, the microcomputer 12051 can perform cooperative control to achieve the functions of an advanced driver assistance system (ADAS), including vehicle collision avoidance or impact mitigation, follow-up running based on the distance between vehicles, vehicle velocity maintenance running, vehicle collision warning, vehicle lane deviation warning, or the like.

Further, the microcomputer 12051 can also perform cooperative control to conduct automatic driving or the like for autonomously running not depending on the operation of the driver, by controlling the driving force generation device, the steering mechanism, the braking device, or the like on the basis of information about the surroundings of the vehicle, the information having being acquired by the external information detection unit 12030 or the in-vehicle information detection unit 12040.

The microcomputer 12051 can also output a control command to the body system control unit 12030, on the basis of the external information acquired by the external information detection unit 12030. For example, the microcomputer 12051 controls the headlamp in accordance with the position of the leading vehicle or the oncoming vehicle detected by the external information detection unit 12030, and performs cooperative control to achieve an anti-glare effect by switching from a high beam to a low beam, or the like.

The sound/image output unit 12052 transmits an audio output signal and/or an image output signal to an out device that is capable of visually or audibly notifying the passenger(s) of the vehicle or the outside of the vehicle of information. In the example shown in FIG. 24, an audio speaker 12061, a display unit 12062, and an instrument panel 12063 are shown as output devices. The display unit 12062 may include an on-board display and/or a head-up display, for example.

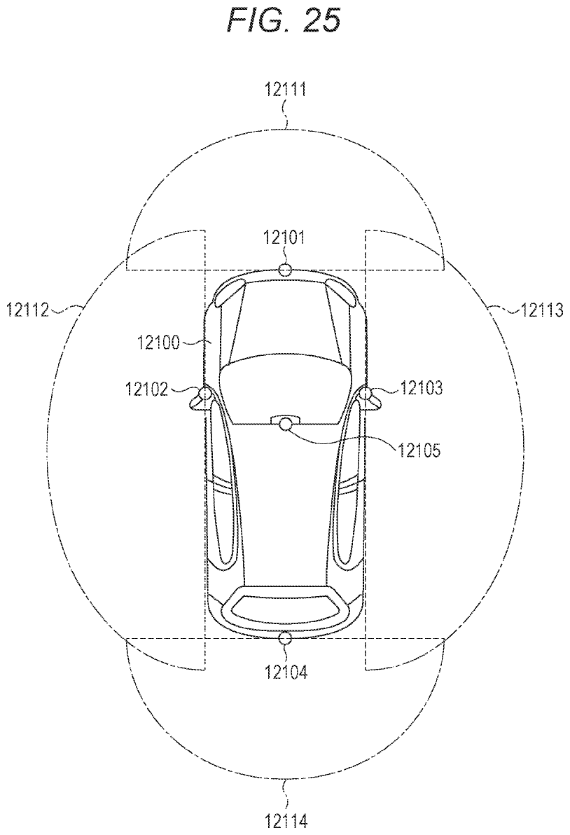

FIG. 25 is a diagram showing an example of installation positions of imaging units 12031.

In FIG. 25, imaging units 12101, 12102, 12103, 12104, and 12105 are included as the imaging unit 12031.

Imaging units 12101, 12102, 12103, 12104, and 12105 are provided at the following positions: the front end edge of a vehicle 12100, a side mirror, the rear bumper, a rear door, an upper portion of the front windshield inside the vehicle, and the like, for example. The imaging unit 12101 provided on the front end edge and the imaging unit 12105 provided on the upper portion of the front windshield inside the vehicle mainly capture images ahead of the vehicle 12100. The imaging units 12102 and 12103 provided on the side mirrors mainly capture images on the sides of the vehicle 12100. The imaging unit 12104 provided on the rear bumper or a rear door mainly captures images behind the vehicle 12100. The imaging unit 12105 provided on the upper portion of the front windshield inside the vehicle as mainly used far detection of a vehicle running in front of the vehicle, a pedestrian, an obstacle, a traffic signal, a traffic sign, a lane, or the like.

Note that FIG. 25 shows an example of the imaging ranges of the imaging units 12101 to 12104. An imaging range 12111 indicates the imaging range of the imaging unit 12101 provided on the front end edge, imaging ranges 12112 and 12113 indicate the imaging ranges of the imaging units 12102 and 12103 provided on the respective side mirrors, and an imaging range 12114 indicates the imaging range of the imaging unit 12104 provided on the rear bumper or a rear door. For example, image data captured by the imaging units 12101 to 12104 are superimposed on one another, so that an overhead image of the vehicle 12100 viewed from above is obtained.

At least one of the imaging units 12101 to 12104 may have a function of acquiring distance information. For example, at least one of the imaging units 12101 to 12104 may be a stereo camera including a plurality of imaging devices, or may be imaging devices having pixels for phase difference detection.

For example, on the basis of distance information obtained from the imaging units 12101 to 12104, the microcomputer 12051 calculates the distances to the respective three-dimensional objects within the imaging ranges 12111 to 12114, and temporal changes in the distances (the velocities relative to The vehicle 12100). In this manner, the three-dimensional object that is the closest three-dimensional object on the traveling path of the vehicle 12100 and is traveling at a predetermined velocity (0 km/h or higher, for example) in substantially the same direction as the vehicle 12100 can be extracted as the vehicle running in front of the vehicle 12100. Further, the microcomputer 12051 can set beforehand an. inter-vehicle distance to be maintained in front of the vehicle running in front of the vehicle 12100, and can perform automatic brake control (including follow-up stop control), automatic acceleration control (including follow-up start control), and the like. In this manner, it is possible to perform cooperative control to conduct automatic driving or the like to autonomously travel not depending on the operation of the driver.

For example, in accordance with the distance information obtained from the imaging units 12101 to 12104, the microcomputer 12051 can extract three-dimensional object data concerning three-dimensional objects under the categories of two-wheeled vehicles, regular vehicles, large vehicles, pedestrians, utility poles, and the like, and use the three-dimensional object data in automatically avoiding obstacles. For example, the microcomputer 12051 classifies the obstacles in the vicinity of the vehicle 12100 into obstacles visible to the driver of the vehicle 12100 and obstacles difficult to visually recognize. The microcomputer 12051 then determines collision risks indicating the risks of collision with the respective obstacles. If a collision risk is equal to or higher than a set value, and there is a possibility of collision, the microcomputer 12051 can output a warning to the driver via the audio speaker 12061 and the display unit 12062, or can perform driving support for avoiding collision by performing forced deceleration or avoiding steering via the drive system control unit 12010.

At least one of the imaging units 12101 to 12104 may be an infrared camera that detects infrared rays. For example, the microcomputer 12051 can recognize a pedestrian by determining whether or not a pedestrian exists in images captured by the imaging units 12101 to 12104. Such pedestrian recognition is carried out through a process of extracting feature points from the images captured by the imaging units 12101 to 12104 serving as infrared cameras, and a process of performing a pattern matching on the series of feature points indicating the outlines of objects and determining whether or not there is a pedestrian, for example. If the microcomputer 12051 determines that a pedestrian exists in the images captured by the imaging units 12101 to 12104, and recognizes a pedestrian, the sound/image output unit 12052 controls the display unit 12062 to display a rectangular contour line for emphasizing the recognized pedestrian in a superimposed manner. Further, the sound/image output unit 12052 may also control the display unit 12062 to display an icon or the like indicating the pedestrian at a desired position.

An example of a vehicle control system to which the technology according to the present disclosure may be applied has been described above. The technology according to the present disclosure can be applied to the imaging unit 12031 in the above described configuration. Specifically, reading in the imaging unit 12031 can be performed in a desired order.

Note that the above described embodiments are examples for embodying the present technology, and the matter of the embodiments corresponds to the subject matter of the claims. Likewise, the subject matter of the claims corresponds to the matter under the same names as the subject matter of the claims in the embodiments of the present technology. However, the present technology is not limited to the embodiments, and various changes can be made to the embodiments without departing from the scope of the technology.

Note that the advantageous effects described in this specification are merely examples and are not limited, and the advantageous effects of the present technology may include other effects.

Note that the present technology may also be embodied in the configurations described below.

(1) A memory circuit including:

a plurality of memory elements;

a counter that sequentially outputs a count value in synchronization with a clock;

a plurality of decoders provided for the respective memory elements, the decoders performing control to read stored contents from the corresponding memory elements when detecting that the count value reaches a predetermined value; and

an output unit that outputs stored contents read from one of the plurality of memory elements.

(2) The memory circuit according to (1), in which

the plurality of decoders detects different values from one another as the predetermined value.

(3) The memory circuit according to (1) or (2), in which

the output unit includes a plurality of output circuits that output stored contents from different memory elements of the plurality of memory elements in accordance with the count value.

(4) The memory circuit according to any one of (1) to (3), further including a transfer unit that has a plurality of stages of shift registers that transfer an output from the output unit to the next stage in synchronization with the clock.

(5) The memory circuit according to (4), in which

the shift registers include first and second shift registers synchronized with the clock, and

the plurality of memory elements, the plurality of decoders, and the counter are provided for each of the first and second shift registers.

(6) The memory circuit according to (4), in which

the shift registers include first and second shift registers synchronized with the clock,

the plurality of memory elements and the plurality of decoders are provided for each of the first and second shift registers, and

the counter is shared between the first and second shift registers.

(7) The memory circuit according to (4), in which

the shift registers include first and second shift registers synchronized with the clock,

the plurality of memory elements is provided for each of the first and second shift registers, and

the counter and the plurality of decoders are shared between the first and second shift registers.

(8) The memory circuit according to any one of (1) to (7), in which

the plurality of memory elements, the plurality of decoders, and the counter constitute a predetermined cluster,

the counter sequentially outputs the count value when the cluster is selected by a cluster selection signal, and

the output unit outputs the read stored contents when the cluster is selected by the cluster selection signal.

(9) The memory circuit according to (8), further including

a transfer unit that has a plurality of stages of shift registers that transfer an output from the output unit to the next stage in synchronization with the clock,

in which an output of one of the clusters is supplied to each of the shift registers in the plurality of stages.

(10) The memory circuit according to (8), further including

a transfer unit that has a plurality of stages of shift registers that transfer an output from the output unit to the next stage in synchronization with the clock,

in which a plurality of the clusters is connected to each of the shift registers in the plurality of stages, and an output of the cluster selected by the cluster selection signal is supplied.

(11) An imaging apparatus including:

a plurality of pixels arranged in a two-dimensional manner;

a plurality of memory elements that store values of the plurality of pixels;

a counter that sequentially outputs a count value in synchronization with a clock;

a plurality of decoders provided for the respective memory elements, the decoders performing control to read stored contents from the corresponding memory elements when detecting that the count value reaches a predetermined value; and

an output unit that outputs stored contents read from one of the plurality of memory elements.

### REFERENCE SIGNS LIST

10 Pixel chip
11 Pixel region
12 Pixel
20 Circuit chip
21 Analog-to-digital (AD) converter circuit region
30 Repeater
31 Cluster
100 Pixel circuit.
200 AD converter circuit
207 Vertical drive circuit
208 Phase locked loop (PLL)
209 Digital-to-analog converter (DAC)
210 Differential input circuit
220 Voltage conversion circuit
230 Positive feedback circuit
250 Digital signal generation unit
300 Memory circuit
310 Write latch circuit
320 Memory element
330 Decoder
400 Time code transfer unit
410 Write transfer circuit
411 Register
412 Buffer
420 Read transfer circuit
421 Register
422 Clock counter
423, 424 Output buffer
510 Time code generation circuit.
520 Pixel data processing circuit
11402, 12031 Imaging unit

1. A memory circuit comprising:
a plurality of memory elements;
a counter that sequentially outputs a count value in synchronization with a clock;
a plurality of decoders provided for the respective memory elements, the decoders performing control to read stored contents from the corresponding memory elements when detecting that the count value reaches a predetermined value; and
an output unit that outputs stored contents read from one of the plurality of memory elements.

2. The memory circuit according to claim 1, wherein
the plurality of decoders detects different values from one another as the predetermined value.

3. The memory circuit according to claim 1, wherein
the output unit includes a plurality of output circuits that output stored contents from different memory elements of the plurality of memory elements in accordance with the count value.

4. The memory circuit according to claim 1, further comprising a transfer unit that has a plurality of stages of shift registers that transfer an output from the output unit to the next stage in synchronization with the clock.

5. The memory circuit according to claim 4, wherein
the shift registers include first and second shift registers synchronized with the clock, and
the plurality of memory elements, the plurality of decoders, and the counter are provided for each of the first and second shift registers.

6. The memory circuit according to claim 4, wherein
the shift registers include first and second shift registers synchronized with the clock,
the plurality of memory elements and the plurality of decoders are provided for each of the first and second shift registers, and
the counter is shared between the first and second shift registers.

7. The memory circuit according to claim 4, wherein
the shift registers include first and second shift registers synchronized with the clock,
the plurality of memory elements is provided for each of the first and second shift registers, and
the counter and the plurality of decoders are shared between the first and second shift registers.

8. The memory circuit according to claim 1, wherein
the plurality of memory elements, the plurality of decoders, and the counter constitute a predetermined cluster,
the counter sequentially outputs the count value when the cluster is selected by a cluster selection signal, and
the output unit outputs the read stored contents when the cluster is selected by the cluster selection signal.

9. The memory circuit according to claim 8, further comprising
a transfer unit that has a plurality of stages of shift registers that transfer an output from the output unit to the next stage in synchronization with the clock,
wherein an output of one of the clusters is supplied to each of the shift registers in the plurality of stages.

10. The memory circuit according to claim 8, further comprising
a transfer unit that has a plurality of stages of shift registers that transfer an output from the output unit to the next stage in synchronization with the clock,
wherein a plurality of the clusters is connected to each of the shift registers in the plurality of stages, and an output of the cluster selected by the cluster selection signal is supplied.

11. An imaging apparatus comprising:
a plurality of pixels arranged in a two-dimensional manner;
a plurality of memory elements that store values of the plurality of pixels;
a counter that sequentially outputs a count value in synchronization with a clock;
a plurality of decoders provided for the respective memory elements, the decoders performing control to read stored contents from the corresponding memory elements when detecting that the count value reaches a predetermined value; and
an output unit that outputs stored contents read from one of the plurality of memory elements.
